(19) United States
(12) Patent Application Publication
(10) Pub. No.: US 2010/0307271 A1
(43) Pub. Date: Dec. 9, 2010

(54) Double teeth ball screw apparatus

(75) Inventors: Yu Ching Hsu, Taichung (TW); Dian-Yu Jan, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 12/455,877

(22) Filed: Jun. 9, 2009

(51) Int. Cl. F16H 55/02

(52) U.S. Cl. 74/424.82

(57) ABSTRACT

A double teeth ball screw device includes an elongated screw shaft and a ball nut each having two parallel helical grooves aligned with each other for forming two parallel ball guiding passages between the screw shaft and the ball nut, the ball nut includes two parallel and axially and oppositely extended channels communicative with the ball guiding passages for forming an endless multiple-turn, helical raceway between the screw shaft and the ball nut and for receiving a number of ball bearing members and for facilitating the sliding movement between the screw shaft and the ball nut, a deflecting device is attached to the ball nut for communicating the ball guiding passages with the channels of the ball nut.

### BACKGROUND OF THE INVENTION

1. Field of the Invention

The present invention relates to a double teeth ball screw apparatus, and more particularly to a double teeth ball screw apparatus including a structure for suitably combining two helical ball guiding passages of the double teeth screw shaft and the double teeth ball nut into a single endless multiple-turn, helical raceway and for allowing the length of the ball nut to be suitably decreased and for allowing the ball screw apparatus to be easily manufactured.

2. Description of the Prior Art

Typical ball screw apparatuses or devices comprise two movable members, such as a ball nut and a screw shaft rotatably engaged with each other and rotatable or movable relative to each other, and a number of ball bearing elements disposed or engaged between the two movable members for facilitating the sliding or rotational movement between the two movable members and for allowing the two movable members to be smoothly moved relative to each other.

For example, U.S. Pat. No. 5,193,409 to Babinski discloses one of the typical ball screw devices comprising a movable member or a ball nut pivotally or rotatably coupled onto or threaded with another movable member or screw shaft, and a multiple circuit internal ball nut return assembly disposed or provided between the screw shaft and the ball nut for receiving the ball bearing elements and for facilitating the movement between the screw shaft and the ball nut. In operation, the screw shaft and the ball nut may rotate relative to each other and may also rotate relative to the ball bearing elements in a great speed.

The internal helically grooved channel or groove of the ball nut complements the external helically grooved channel or groove of the screw shaft, and the helical grooves cooperate to define a multiple turn, helical raceway in which the ball bearing elements are received.

However, the multiple turn, helical raceway includes two or more endless ball guiding passages that are separated from each other and each of which require two or more turns of the helical grooves to form the endless ball guiding passages, such that the length of the screw shaft and the ball nut will be increased and such that the typical ball screw devices may not be easily manufactured or assembled.

U.S. Pat. No. 5,492,036 to Sato discloses another typical ball screw device also comprising a ball nut pivotally or rotatably coupled onto or threaded with a screw shaft, and a single endless ball guiding passage formed or provided between the screw shaft and the ball nut for receiving the ball bearing elements, and two or more turns of the helical grooves are also required to form the endless ball guiding passage.

However, the single endless ball guiding passage is good for the single tooth ball screw apparatus, and may not be used for the double teeth ball screw apparatus.

U.S. Pat. No. 5,749,266 to Tsukada discloses a further typical ball screw device also comprising a ball nut pivotally or rotatably coupled onto or threaded with a screw shaft, and a single endless ball guiding passage formed or provided between the screw shaft and the ball nut for receiving the ball bearing elements, and two or more turns of the helical grooves are also required to form the endless ball guiding passage.

However, similarly, the single endless ball guiding passage is good for the single tooth ball screw apparatus, and may not be used for the double teeth ball screw apparatus.

The present invention has arisen to mitigate and/or obviate the afore-described disadvantages of the conventional ball screw apparatuses.

### SUMMARY OF THE INVENTION

The primary objective of the present invention is to provide a double teeth ball screw apparatus including a structure for suitably combining two helical ball guiding passages of the double teeth screw shaft and the double teeth ball nut into a single endless multiple-turn, helical raceway and for allowing the length of the ball nut to be suitably decreased and for allowing the ball screw apparatus to be easily manufactured.

In accordance with one aspect of the invention, there is provided a double teeth ball screw apparatus comprising an elongated screw shaft including a first helical groove and a second helical groove formed in an outer peripheral portion thereof and parallel to each other, a ball nut movably attached onto the elongated screw shaft, and including a bore formed therein for receiving the elongated screw shaft, and including a first helical groove and a second helical groove formed in an inner peripheral portion thereof and parallel to each other, the first helical groove of the screw shaft being aligned with the first helical groove of the ball nut for forming a first ball guiding passage between the screw shaft and the ball nut, and the second helical groove of the screw shaft being aligned with the second helical groove of the ball nut for forming a second ball guiding passage between the screw shaft and the ball nut, the ball nut including a first channel and a second channel axially and oppositely formed therein, the first channel of the ball nut being communicative with a first end of the first ball guiding passage and a second end of the second ball guiding passage, and the second channel of the ball nut being communicative with a second end of the first ball guiding passage and a first end of the second ball guiding passage for forming an endless multiple-turn, helical raceway between the screw shaft and the ball nut and for allowing the length of the ball nut to be suitably decreased and for allowing the ball screw apparatus to be easily manufactured, and a number of ball bearing members received in the endless multiple-turn, helical raceway that is formed between the screw shaft and the ball nut for facilitating a movement between the screw shaft and the ball nut.

A deflecting device may further be provided and attached to the ball nut for communicating the first ball guiding passage and the second ball guiding passage with the first channel and the second channel of the ball nut.

The deflecting device includes two first deflectors each having a deflecting pathway formed therein for communicating the first channel of the ball nut with the first end of the first ball guiding passage and the second end of the second ball guiding passage, and two second deflectors each having a deflecting pathway formed therein for communicating the second channel of the ball nut with the second end of the first ball guiding passage and the first end of the second ball guiding passage.

The ball nut includes two first depressions formed therein and communicative with the first channel of the ball nut for receiving the first deflectors, and includes two second depressions formed therein and communicative with the second channel of the ball nut for receiving the second deflectors.

Alternatively, the deflecting device may include two ring members attached or mounted to the two side or end portions of the ball nut, and the ring members each include a bore formed therein for receiving the screw shaft and each include two deflecting pathways formed therein and communicative with the channels of the ball nut respectively for communicating the ends of the ball guiding passages with each other and for forming the single endless multiple-turn, helical raceway between the screw shaft and the ball nut.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a double teeth ball screw apparatus in accordance with the present invention;

FIG. 2 is a perspective view of the double teeth ball screw apparatus;

FIG. 3 is a perspective view similar to FIG. 2 illustrating the operation of the double teeth ball screw apparatus;

FIG. 4 is an exploded view similar to FIG. 1 illustrating the other arrangement of the double teeth ball screw apparatus;

FIG. 5 is a perspective view of the double teeth ball screw apparatus as shown in FIG. 4; and

FIG. 6 is a perspective view illustrating the operation of the double teeth ball screw apparatus as shown in FIGS. 4 and 5.

### DETAILED DESCRIPTION OF THE PREFERRED EMBODIMENT

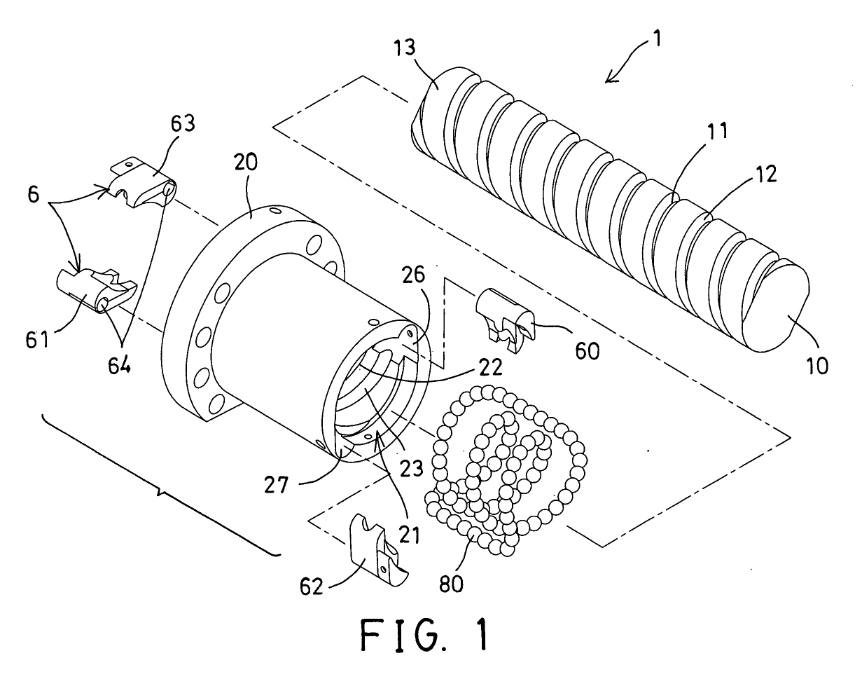

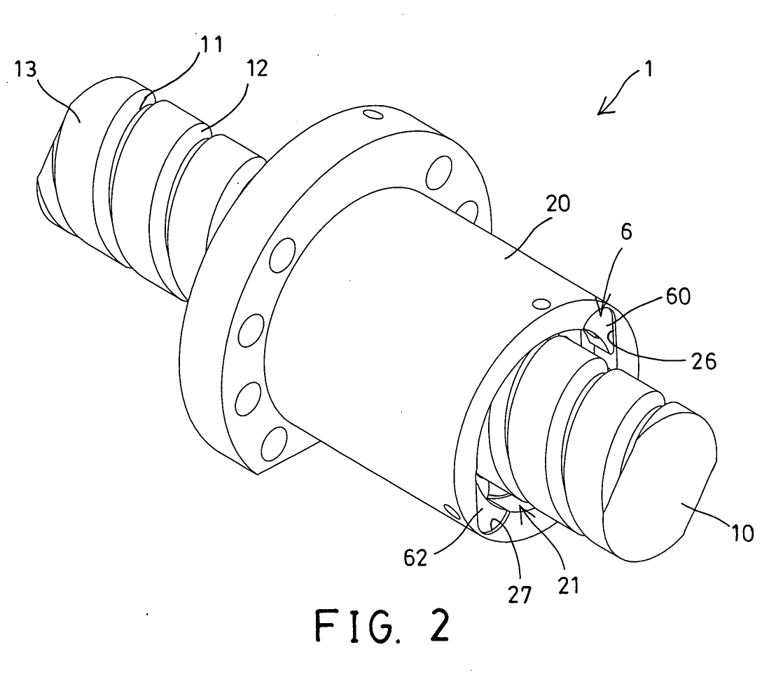

Referring to the drawings, and initially to FIGS. 1-3, a ball screw apparatus 1 in accordance with the present invention, such as a double teeth ball screw device 1, comprises an elongated bolt or screw shaft 10 including a first helical threaded portion or groove 11 and a second helical threaded portion or groove 12 formed on the outer peripheral portion thereof, or formed in the outer peripheral surface 13 thereof and arranged parallel to each other, and a movable member, such as a ball nut 20 including a screw hole or bore 21 formed therein for receiving or engaging with the elongated screw shaft 10 and for movably attaching onto the elongated screw shaft 10, and the screw hole or bore 21 of the ball nut 20 is formed or defined by a first helical threaded portion or groove 22 and a second helical threaded portion or groove 23 which are formed in an inner peripheral portion of the ball nut 20 and arranged parallel to each other.

The first helical threaded portion or groove 11 of the screw shaft 10 is aligned with the first helical threaded portion or groove 22 of the ball nut 20 for forming a first ball guiding passage 30 between the screw shaft 10 and the ball nut 20, and the second helical threaded portion or groove 12 of the screw shaft 10 is aligned with the second helical threaded portion or groove 23 of the ball nut 20 for forming a second ball guiding passage 40 between the screw shaft 10 and the ball nut 20, the ball nut 20 includes two channels 24, 25 longitudinally or axially and oppositely formed in the outer peripheral portion thereof, and intersecting or communicating with the ball guiding passages 30, 40 for forming a single endless multiple-turn, helical raceway 50 and for slidably receiving a number of ball bearing members 80 and for facilitating the sliding or rotational movement between the two movable members 10, 20 or the screw shaft 10 and the ball nut 20.

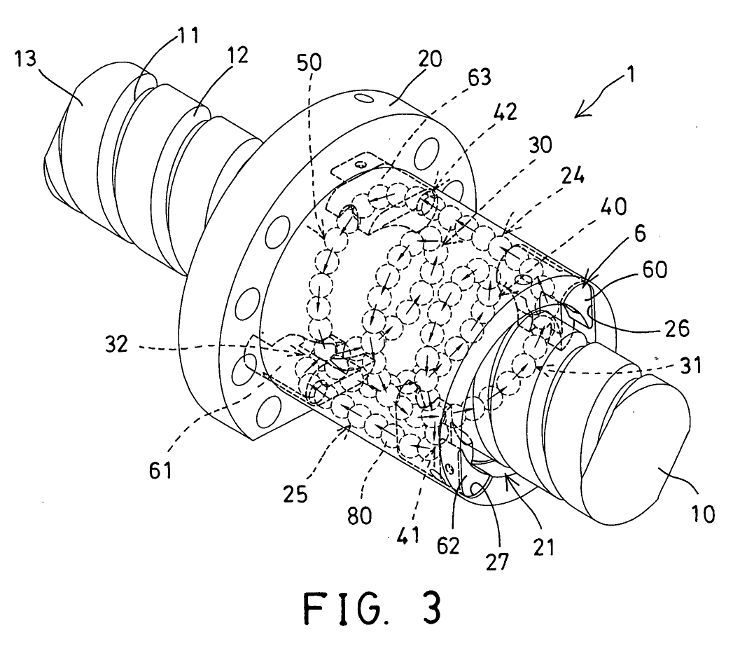

For example, as shown in FIG. 3, the channel 24 of the ball nut 20 is communicating with the first end 31 of the ball guiding passage 30 and the second end 42 of the ball guiding passage 40, and the other channel 25 of the ball nut 20 is communicating with the second end 32 of the ball guiding passage 30 and the first end 41 of the ball guiding passage 40 for forming the single endless multiple-turn, helical raceway 50 and for slidably receiving the ball bearing members 80, best shown in FIGS. 1 and 3. The ball nut 20 further includes four depressions 26, 27 formed therein and arranged and intersected or communicated with the channels 24, 25 of the ball nut 20 respectively for receiving or attaching or engaging with a deflecting device 6 which is attached to the ball nut 20 and which includes four deflectors 60, 61, 62, 63 received or engaged in the depressions 26, 27 of the ball nut 20 respectively.

For example, the deflectors 60, 63 are received or engaged in the depressions 26 of the ball nut 20 respectively and are intersected or communicated with the channel 24 of the ball nut 20 and/or each include a deflecting pathway 64 formed therein for communicating the first end 31 of the ball guiding passage 30 and the second end 42 of the ball guiding passage 40 with the channel 24 of the ball nut 20, and the other deflectors 61, 62 are received or engaged in the other depressions 27 of the ball nut 20 respectively and are intersected or communicated with the other channel 25 of the ball nut 20 and/or each include a deflecting pathway 64 formed therein for communicating the second end 32 of the ball guiding passage 30 and the first end 41 of the ball guiding passage 40 with the other channel 25 of the ball nut 20, and for guiding or deflecting or returning the ball bearing members 80 to move cyclically in the endless multiple-turn, helical raceway 50 of the double teeth ball screw device 1.

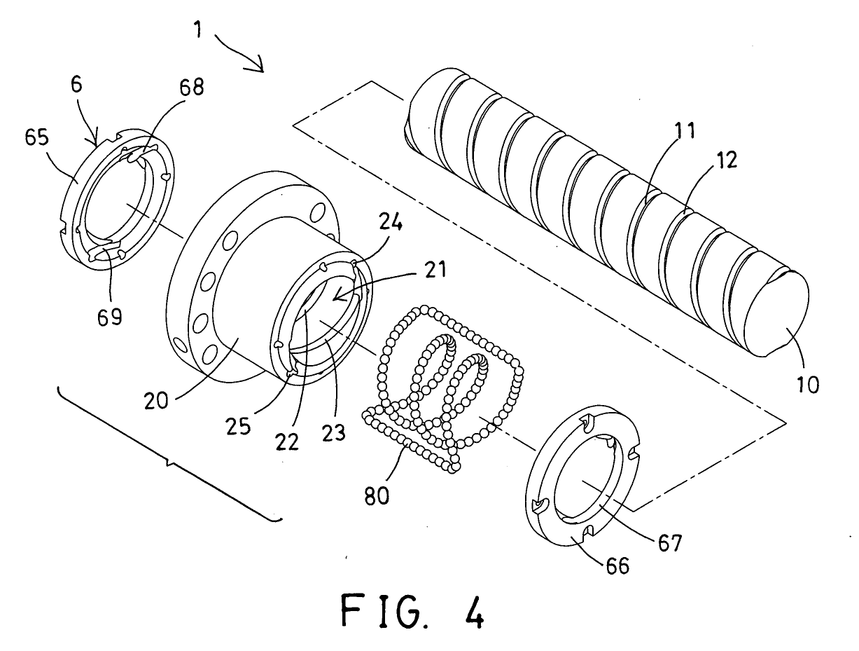

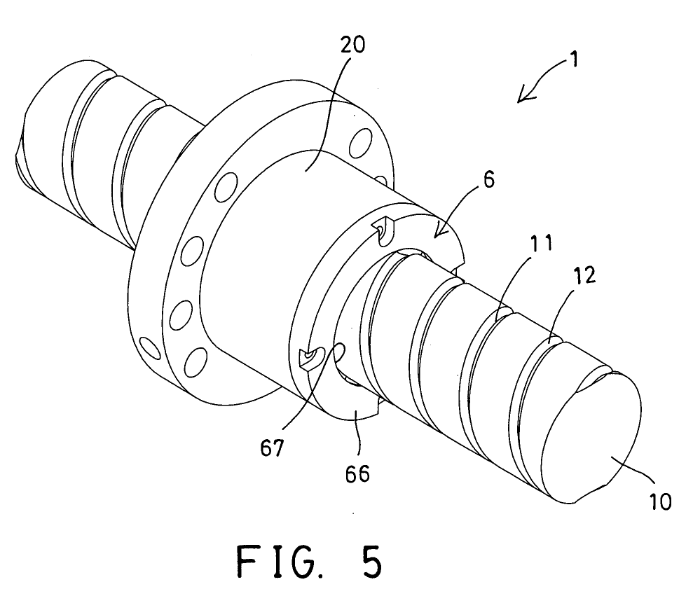

Alternatively, as shown in FIGS. 4-6, instead of the four deflectors 60, 61, 62, 63, the deflecting device 6 may include two annular or ring members 65, 66 attached or mounted to the two side or end portions of the ball nut 20, and the ring members 65, 66 each include a bore 67 formed therein for receiving the screw shaft 10 and each include two deflecting pathways 68, 69 formed therein and arranged and intersected or communicated with the channels 24, 25 of the ball nut 20 respectively for communicating the ends 31, 32, 41, 42 of the ball guiding passages 30, 40 with each other and for forming the single endless multiple-turn, helical raceway 50 between the screw shaft 10 and the ball nut 20.

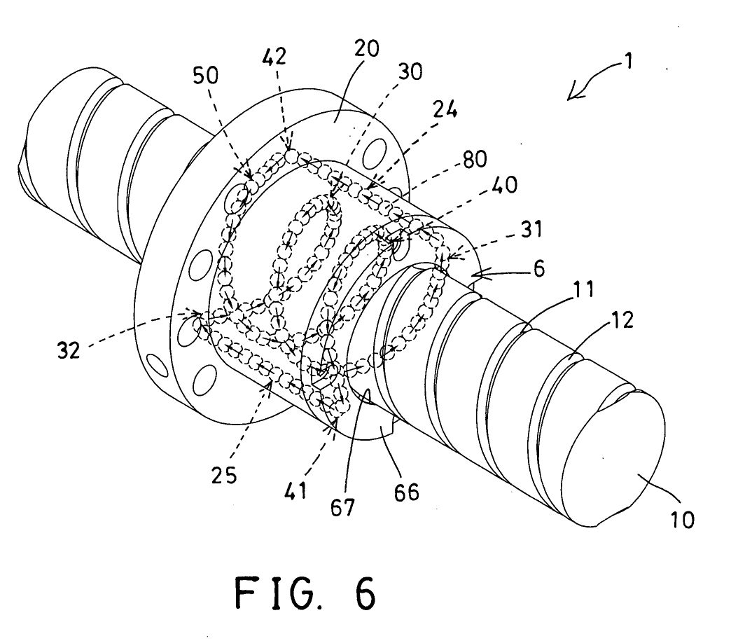

In operation, as shown in FIGS. 3 and 6, the external helical grooves 11, 12 of the screw shaft 10 complement the internal helical grooves 22, 23 of the ball nut 20, and the helical grooves 11, 12, 22, 23 cooperate to define the ball guiding passages 30, 40 between the screw shaft 10 and the ball nut 20, and for forming the single endless multiple-turn, helical raceway 50 between the screw shaft 10 and the ball nut 20 and for slidably receiving the ball bearing members 80. It is to be noted that the two ball guiding passages 30, 40 may be communicated with each other for forming the single endless multiple-turn, helical raceway 50, and each ball guiding passage 30, 40 requires only 1.5 turn to form the helical raceway 50, for allowing the length of the screw shaft 10 and the ball nut 20 to be suitably decreased and for allowing the ball screw apparatus 1 to be easily manufactured.

Accordingly, the double teeth ball screw apparatus in accordance with the present invention includes a structure for suitably combining two helical ball guiding passages of the double teeth screw shaft and the double teeth ball nut into a single endless multiple-turn, helical raceway and for allowing the length of the ball nut to be suitably decreased and for allowing the ball screw apparatus to be easily manufactured.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A double teeth ball screw apparatus comprising:
an elongated screw shaft including a first helical groove and a second helical groove formed in an outer peripheral portion thereof and parallel to each other,
a ball nut movably attached onto said elongated screw shaft, and including a bore formed therein for receiving said elongated screw shaft, and including a first helical groove and a second helical groove formed in an inner peripheral portion thereof and parallel to each other,
said first helical groove of said screw shaft being aligned with said first helical groove of said ball nut for forming a first ball guiding passage between said screw shaft and said ball nut, and said second helical groove of said screw shaft being aligned with said second helical groove of said ball nut for forming a second ball guiding passage between said screw shaft and said ball nut,
said ball nut including a first channel and a second channel axially and oppositely formed therein, said first channel of said ball nut being communicative with a first end of said first ball guiding passage and a second end of said second ball guiding passage, and said second channel of said ball nut being communicative with a second end of said first ball guiding passage and a first end of said second ball guiding passage for forming an endless multiple-turn, helical raceway between said screw shaft and said ball nut, and
a plurality of ball bearing members received in said endless multiple-turn, helical raceway that is formed between said screw shaft and said ball nut for facilitating a movement between said screw shaft and said ball nut.

2. The double teeth ball screw apparatus as claimed in claim 1, wherein a deflecting device is attached to said ball nut for communicating said first ball guiding passage and said second ball guiding passage with said first channel and said second channel of said ball nut.

3. The double teeth ball screw apparatus as claimed in claim 2, wherein said deflecting device includes two first deflectors each having a deflecting pathway formed therein for communicating said first channel of said ball nut with said first end of said first ball guiding passage and said second end of said second ball guiding passage, and two second deflectors each having a deflecting pathway formed therein for communicating said second channel of said ball nut with said second end of said first ball guiding passage and said first end of said second ball guiding passage.

4. The double teeth ball screw apparatus as claimed in claim 3, wherein said ball nut includes two first depressions formed therein and communicative with said first channel of said ball nut for receiving said first deflectors, and includes two second depressions formed therein and communicative with said second channel of said ball nut for receiving said second deflectors.
